(19) United States
(12) Patent Application Publication
(10) Pub. No.: US 2013/0340719 A1
(43) Pub. Date: Dec. 26, 2013

(54) METHOD FOR OPERATING AN INJECTION SYSTEM FOR AN INTERNAL COMBUSTION ENGINE

(71) Applicants: Andreas Gutscher, Markgroeningen (DE); Andreas Posselt, Muehlacker (DE); Marko Lorenz, Grossbottwar (DE)

(72) Inventors: Andreas Gutscher, Markgroeningen (DE); Andreas Posselt, Muehlacker (DE); Marko Lorenz, Grossbottwar (DE)

(21) Appl. No.: 13/997,345

(22) PCT Filed: Nov. 9, 2011
(86) PCT No.: PCT/EP2011/069702

§ 371 Date: Sep. 16, 2013

(30) Foreign Application Priority Data
Dec. 27, 2010 (DE) 102010064184.7

(51) Int. Cl. F02D 41/30

(52) U.S. Cl. CPC F02D 41/30
USPC 123/478

(57) ABSTRACT

In a method for operating an injection system for an internal combustion engine having a combustion chamber, in a first method step, a first inlet valve to the combustion chamber is opened and fuel is injected into the combustion chamber through the open first inlet valve by a first injector, and in the first method step, a second inlet valve to the combustion chamber is furthermore opened and fuel is injected into the combustion chamber through the open second inlet valve by a second injector, and in a second method step, additional fuel is subsequently injected into the combustion chamber through the still open first inlet valve by the first injector.

### BACKGROUND OF THE INVENTION

1. Field of the Invention

The present invention is directed to a method for operating an injection system for an internal combustion engine.

2. Description of the Related Art

Such injection systems for internal combustion engines are generally known. For example, an internal combustion engine having at least one combustion chamber is known from published German patent application document DE 10 2008 044 244 A1, the combustion chamber having two fuel inlet ports, each of which may be closed off by an inlet valve. The internal combustion engine furthermore has a fuel injection device which has, assigned to the at least one combustion chamber, a first and a separate second injector for metered fuel injection into at least one intake channel of the combustion chamber. The injectors inject the fuel in the direction of the inlet valves atomized in the form of spray cones.

Furthermore, it is also known from the related art to compute with the aid of load prediction methods the fuel quantity needed in the future and to accordingly activate the injector for injecting the computed fuel quantity into the intake manifold. However, in internal combustion engines having an intake manifold injection system, the fuel injection usually takes place chronologically prior to the intake stroke. Now, if the throttle valve is suddenly opened wide chronologically after the injection, e.g., because the driver of the motor vehicle requests an increased torque, more air flows into the combustion chamber than was originally assumed for the computation of the required fuel quantity. Since the injection process is already completed at this point in time, it is no longer possible to adjust the quantity of fuel to the larger air quantity, so that the air/fuel mixture is leaned and thus there is the risk of a power drop up to misfires. This object is achieved in that a secondary injection of additional fuel is carried out as long as the inlet valve is still open. Such a mode of operation is known from published German patent application document DE 103 48 248 A1 and published German patent application document DE 10 2004 004 333 A1, for example. However, the disadvantage here is that, compared to the initial injection process, only a very small quantity of fuel must be subsequently injected during the secondary injection process. The size of the through flow of an injector, however, simultaneously establishes the minimum quantity which it is still possible to output with an appropriate accuracy. The injector known from the related art, which is usually designed for injecting larger quantities of fuel, may thus only be actuated for a very short period, thus giving rise to a great relative deviation from the computed setpoint value of the injected fuel quantity. Furthermore, there is the risk that the injector works in a non-linear range due to the short turn-on pulse, whereby the deviation from the setpoint value further increases. A precise secondary injection is thus not possible.

### BRIEF SUMMARY OF THE INVENTION

The method according to the present invention for operating an injection system for an internal combustion engine has the advantage over the related art that a precise secondary injection of additional fuel into the combustion chamber is made possible. This is achieved in that in the first method step, two separate injectors are used for the fuel injection so that every single injector must be designed for a smaller through flow of fuel, compared to the situation where only a single injector should have to inject the entire fuel quantity in the first method step. In this way, the minimum quantity, which may still be injected by the injectors with high accuracy, is advantageously reduced. In the case of a relatively small through flow, the activation times for each inlet valve to inject the same quantity of fuel are furthermore longer, so that a longer activation pulse for the secondary injection of the additional fuel is needed in the second method step. In this way, the precision of the secondary injection process is considerably increased and the risk of the first injector working in a non-linear range is eliminated. The method according to the present invention thus allows a very precise injection of the needed fuel quantity even in the case of dynamic operating modes which are caused by great load changes. In this way, the engine output during load changes, e.g., from no-load to full load or from a small load to a great load, is increased. By setting an almost optimal air/fuel mixture, the mixing and combustion are furthermore enhanced, thus achieving an improved smooth running and a reduced CO₂ emission during load changes. The internal combustion engine according to the present invention preferably includes a gasoline engine having an intake manifold injection for a motor vehicle, preferably an automobile. The internal combustion engine preferably includes more than one cylinder, each cylinder including a combustion chamber having two spark plugs and two inlet valves, a separate injector being assigned to each inlet valve.

According to one preferred specific embodiment of the present invention, it is provided that in the second method step, additional fuel is subsequently injected into the combustion chamber through the still open first inlet valve exclusively by the first injector. The first and the second injectors are thus preferably activated independently of one another. In this case, the secondary injection takes place exclusively by the first injector so that the smallest possible quantity of fuel is injectable. Alternatively, it is provided that in the second method step, additional fuel is subsequently injected into the combustion chamber through the still open second inlet valve by the second injector, as well. In this case, the first and the second injectors may be activated together. It is conceivable to variably switch between the two secondary injection variants depending on the fuel need, so that the available fuel quantity metering range is considerably increased compared to the related art.

According to one preferred specific embodiment of the present invention, it is provided that in the first method step, essentially the same quantity of fuel is injected by the first and the second injectors. Advantageously, the first and the second injectors thus have the same design. The use of these two injectors results in the possible minimum injection quantity being halved compared to the related art. During the “normal” injection phase, a uniform distribution of the fuel/air mixture in the combustion chamber is advantageously achieved due to the identical dimensions of the injectors.

According to one preferred specific embodiment of the present invention, it is provided that in the first method step, a smaller quantity of fuel is injected by the first injector than by the second injector. In this alternative specific embodiment, the first and the second injectors have different dimensions. This has the advantage that an even smaller minimum injection quantity of the first injector may be achieved. For the secondary injection, only the first injector is then activated in such a way that smallest quantities of additional fuel may be advantageously subsequently injected in a precise manner. The fuel quantity metering range is thereby considerably increased compared to the related art. Preferably, in the first method step, a quantity of fuel is injected by the first injector, this quantity of fuel being smaller than 60 percent, preferably smaller than 30 percent, particularly preferably smaller than 20 percent, and exceptionally preferably smaller than 10 percent of the quantity of fuel which is injected by the second injector in the first method step. The minimum injection quantity may thus be reduced to less than 30 percent, preferably to less than 15 percent, particularly preferably to less than 10 percent, and exceptionally preferably to less than 5 percent, compared to the related art.

According to one preferred specific embodiment of the present invention, it is provided that the fuel is injected by the first injector directly adjacently to the first inlet port. This has the advantage that the flight time for the subsequently injected additional fuel is comparably short so that it is possible to initiate a secondary injection at a very late point in time.

According to one preferred specific embodiment of the present invention, it is provided that in the second method step, the first injector is activated as a function of a secondary injection signal for subsequently injecting the additional fuel. The secondary injection signal is generated when, for example, corresponding measuring data detect a leaned air/fuel mixture and/or the software of an engine control unit predicts a leaned air/fuel mixture.

According to one preferred specific embodiment of the present invention, it is provided that the secondary injection signal is generated as a function of a rotational speed of the internal combustion engine, a throttle valve setting of the internal combustion engine, and/or of the signals of a lambda sensor situated in an exhaust gas channel of the internal combustion engine, of an air mass flow sensor situated in an intake manifold of the internal combustion engine, of a pressure sensor and/or a temperature sensor situated in the intake manifold. Advantageously, a determination of a leaned air/fuel mixture is possible based on the above-named data.

Exemplary embodiments of the present invention are illustrated in the drawings and explained in greater detail in the description below.

### BRIEF DESCRIPTION OF THE DRAWINGS

FIG. 1 shows a schematic illustration of an injection system for an internal combustion engine which carries out a first method step of a method according to one exemplary specific embodiment of the present invention.

FIG. 2 shows a schematic illustration of an injection system for an internal combustion engine which carries out a second method step of a method according to one exemplary specific embodiment of the present invention.

### DETAILED DESCRIPTION OF THE INVENTION

In the different figures, identical parts are always provided with identical reference numerals and are thus each named or mentioned only once as a rule.

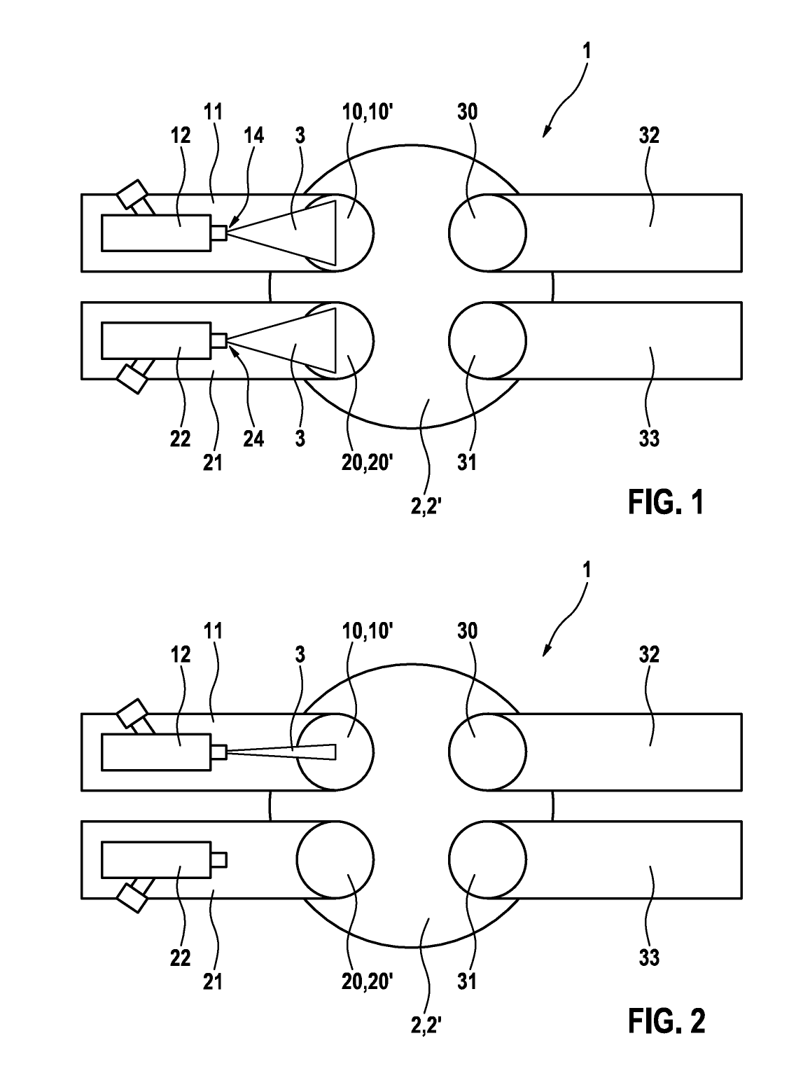

FIG. 1 shows a schematic illustration of an injection system for an internal combustion engine 1 which carries out a first method step of a method according to one exemplary specific embodiment of the present invention which has a cylinder which includes a combustion chamber 2 and in which a piston 2′ moves. The wall of combustion chamber 2 has a first and a second inlet port 10′, 20′ through each of which an air/fuel mixture is taken in into combustion chamber 2 and a first and a second outlet port 30, 31 through which the untreated exhaust gases of the combusted air/fuel mixture are expelled into first and second outlet channels 32, 33 from combustion chamber 2. Internal combustion engine 1 has a first inlet valve 10 which is provided for closing off first inlet port 10′ and is situated between a first intake channel 11 and combustion chamber 2. Internal combustion engine 1 furthermore has a second inlet valve 20 which is provided for closing off second inlet port 20′ and is situated between a second intake channel 21 and combustion chamber 2. First and second intake channels 11, 21 end in a shared intake manifold (not illustrated) on a side facing away from combustion chamber 2, fresh air being taken in through a throttle valve (not illustrated), which is situated in the intake manifold, through the intake manifold in the direction of combustion chamber 2. In first intake channel 11, a first injector 12 is situated which has a first injection opening 14 through which a fuel mixture 3 is sprayed through first intake channel 11 in the area of first inlet port 10′. Similarly, in second intake channel 21, a separate second injector 22 is situated which has a single second injection opening 24 through which a fuel mixture 3 is sprayed through second intake channel 21 in the area of second inlet port 20′.

During normal vehicle operation, a predetermined quantity of fuel 3 is injected and atomized in each cycle by first and second injectors 12, 22 into first and second intake manifolds 11, 12. This takes place within the scope of the first method step which is illustrated in FIG. 1. The air/fuel mixture emerging in each case reaches combustion chamber 2 through first and second inlet valves 10, 20. The quantity of fuel 3 to be injected is computed with the aid of a prediction method. During a dynamic vehicle operation, the computed injection quantity does not exactly correspond to the actual air filling, since a change in the filling, e.g., due to a suddenly occurring load change, may occur between the computing point in time of the air filling and the actually completed injection, including the flight time. Such a load change may occur, for example, when the driver of the motor vehicle requests an increased torque and the throttle valve thus opens suddenly. Then, more air flows into combustion chamber 2 than that which the computation of the needed fuel quantity was based on. Thus, too much air with regard to the computed and injected fuel quantity enters the cylinder, causing a leaning of the air/fuel mixture. To solve this problem, additional fuel 3′ is subsequently injected into combustion chamber 2 by first injector 11 through still open first inlet valve 10 in a second method step illustrated based on FIG. 2.

FIG. 2 shows a schematic illustration of the injection system already illustrated in FIG. 1 for an internal combustion engine 1, the second method step of the method according to the exemplary specific embodiment of the present invention being schematically illustrated in FIG. 2. In the second method step, a small quantity of additional fuel 3′ is subsequently injected by first injector 12 at a later point in time to enrich again the leaned air/fuel mixture in combustion chamber 2 with fuel to obtain a desirable optimal ratio. Second injector 22 is not operated at this point in time.

During a secondary injection, the problem basically arises that the injector has trouble metering very small quantities. The size of through flow Qₛₜₐₜ of an injector establishes at the same time the smallest possible injection quantity, also referred to as minimum quantity Qₘᵢₙ. Minimum quantity Qₘᵢₙ is a quantity which may just be injected by an injector with a certain accuracy. In the case of present internal combustion engine 1, two same-sized separate injectors, first and second injectors 12, 22, are used so that the through flow of the two injectors 12, 22 is halved and minimum quantity Qₘᵢₙ is therefore also halved for each of the two injectors 12, 22. First injector 12 is thus used for a precise secondary injection of a particularly small quantity of additional fuel 3′ (indicated in FIG. 2 only schematically by a smaller spray cone). Alternatively, it is conceivable that first and second injectors 12, 22 have different dimensions so that first injector 12 has through flow Qₛₜₐₜ₁ for example, which is smaller than through flow Qₛₜₐₜ₂ of second injector 22. In this way, the secondary injections may be metered for the particular combustion in an even finer and more coordinated manner.

1-11. (canceled)

12. A method for operating an injection system for an internal combustion engine having a combustion chamber, comprising:
performing, in a first method step, the following: (i) opening a first inlet valve to the combustion chamber and injecting fuel into the combustion chamber through the open first inlet valve by a first injector of the injection system, and (ii) opening a second inlet valve to the combustion chamber and injecting fuel into the combustion chamber through the open second inlet valve by a second injector of the injection system; and
subsequently injecting, in a second method step, additional fuel into the combustion chamber through the still open first inlet valve by at least the first injector.

13. The method as recited in claim 12, wherein in the second method step, the additional fuel is subsequently injected into the combustion chamber through the still open first inlet valve exclusively by the first injector.

14. The method as recited in claim 12, wherein in the second method step, the additional fuel is subsequently injected into the combustion chamber through the still open second inlet valve also by the second injector.

15. The method as recited in claim 13, wherein in the first method step, essentially the same quantity of fuel is injected by the first and the second injectors.

16. The method as recited in claim 13, wherein in the first method step, a smaller quantity of fuel is injected by the first injector than by the second injector.

17. The method as recited in claim 16, wherein in the first method step, the quantity of fuel injected by the first injector is smaller than 60 percent of the quantity of fuel injected by the second injector.

18. The method as recited in claim 13, wherein the fuel is injected by the first injector directly adjacently to a first inlet port associated with the first inlet valve.

19. The method as recited in claim 13, wherein in the second method step, the first injector is activated as a function of a secondary injection signal for subsequently injecting the additional fuel, the secondary injection signal being generated when an air portion of an air/fuel mixture exceeds a predetermined upper limit.

20. The method as recited in claim 19, wherein the secondary injection signal is generated as a function of at least one of: a rotational speed of the internal combustion engine; a throttle valve setting of the internal combustion engine; a signal of a lambda sensor situated in an exhaust gas channel of the internal combustion engine; a signal of an air mass flow sensor situated in an intake manifold of the internal combustion engine; a signal of a pressure sensor situated in the intake manifold; and a signal of a temperature sensor situated in the intake manifold.

21. A non-transitory, computer-readable data storage medium storing a computer program having program codes which, when executed on a computer, perform a method for operating an injection system for an internal combustion engine having a combustion chamber, the method comprising:
performing, in a first method step, the following: (i) opening a first inlet valve to the combustion chamber and injecting fuel into the combustion chamber through the open first inlet valve by a first injector of the injection system, and (ii) opening a second inlet valve to the combustion chamber and injecting fuel into the combustion chamber through the open second inlet valve by a second injector of the injection system; and
subsequently injecting, in a second method step, additional fuel into the combustion chamber through the still open first inlet valve by at least the first injector.
